(19) United States
(12) Patent Application Publication
(10) Pub. No.: US 2010/0170769 A1
(43) Pub. Date: Jul. 8, 2010

(54) MOVING MACHINE

(76) Inventor: Dong Geun Jung, Daejeon-si (KR)

Correspondence Address: CHRISTOPHER PAUL MITCHELL, 888 16TH ST., NW, SUITE 800, WASHINGTON, DC, 20006, US

(21) Appl. No.: 12/602,145

(22) PCT Filed: Aug. 30, 2007
(86) PCT No.: PCT/KR07/04186

§ 371 Date: Nov. 27, 2009

(30) Foreign Application Priority Data
Jul. 11, 2007 (KR) 10-2007-0069773

(51) Int. Cl. B65G 37/00

(52) U.S. Cl. 198/570

(57) ABSTRACT

Provided is a moving machine including: a moving belt forming a first endless track by connecting both ends of a tube having a second endless track; a first drive module coupled to both inner sides of the first endless track to rotate the first endless track and the second endless track; a frame coupled to the first drive module to provide a predetermined tension to the first endless track; and a controller for controlling the first drive module.

### TECHNICAL FIELD

The present invention relates to a moving machine, and more particularly, to a moving machine capable of endlessly moving in relation to a virtual reality program in a direction desired by a user.

### BACKGROUND ART

Generally, a virtual reality system enables a user to experience virtual reality provided by a virtual reality program, and detects motion of the user to control the virtual reality program. Here, in order to detect the motion of the user and display the motion on a screen, the system detects a user s voice and motion of a user s arms, legs, fingers, and so on, to control the virtual reality.

At this time, since virtual reality is experienced in a limited space, a user can only move his/her arms and legs within a specified area when going for a walk or a jog, for example, in the virtual reality program.

Though a treadmill can be adapted to walking, jogging or the like, since the user can only move in a single direction, it is difficult to experience the virtual reality properly.

### DISCLOSURE OF INVENTION

### Technical Problem

In order to solve the foregoing and/or other problems, it is an aspect of the present invention to provide a moving machine capable of endlessly moving in a direction desired by a user, and a virtual reality experience through interaction with a virtual reality program.

### Technical Solution

The foregoing and/or other aspects of the present invention may be achieved by providing a moving machine including: a moving belt forming a first endless track by connecting both ends of a tube having a second endless track; a first drive module coupled to both inner sides of the first endless track to rotate the first endless track and the second endless track; a frame coupled to the first drive module to provide a predetermined tension to the first endless track; and a controller for controlling the first drive module.

Here, the first drive module may include: a first drum rotatably fixed to the frame and installed in the first endless track to rotate the first endless track; a first drive member for driving the first drum; a first rotary body installed to be in contact with the moving belt to rotate the second endless track; and a second drive member for driving the first rotary body.

In addition, the first drum may include a first support member disposed at an outer periphery thereof and extending in a longitudinal direction thereof, the first rotary body rotatably installed at the first support member, and the second drive member installed in the first drum to rotate the first rotary body through a second power transmission member.

Further, the first drum may include a belt guider coupled to both longitudinal sides thereof to guide the moving belt, and the belt guider may include a belt detection sensor for detecting the belt to control speed of the first rotary body.

Furthermore, the belt guider may be a frame for supporting the first drum, and the belt detection sensor may be disposed on the frame.

The second endless track may be filled with a lubricant, and may include permanent magnets disposed opposite to the same polarity to prevent friction therebetween.

The first endless track may include a support member disposed therein and supporting the moving belt, and the support member may include: a durable support layer for supporting a lower surface of the moving belt; a magnetic layer disposed on the support layer and preventing friction using a magnetic force against the moving belt; a detection layer for detecting a user on the moving belt; and a lubricating layer disposed at the uppermost layer and reducing friction against the moving belt when the lubricating layer is in contact with the moving belt.

In addition, the moving machine may further include first bearings installed at both edges of the support member and guiding the moving belt to reduce friction.

Meanwhile, the moving belt may include a second drive module installed outside the first endless track to rotate the first endless track and the second endless track.

Further, the second endless track may include a third drive module for supporting upper and lower parts of the second endless track and rotating the second endless track in an endless manner, and the third drive module may include a drive belt for forming a closed loop outside the second endless track and supporting upper and lower parts of the second endless track to rotate the second endless track in an endless manner, a third rotary body for rotating the drive belt, and a fifth drive member for driving the third rotary body.

In addition, the drive belt may include drive blocks installed at the drive belt at predetermined intervals and rotating the second endless track, and the drive block may include at least one drive ring disposed at an outer periphery of the drive block to increase traction with the second endless track.

Meanwhile, the drive belt may include adhesion members disposed on and under the drive belt and pressing the drive belt to be in contact with the first endless track, and the adhesion member may include a second bearing for reducing friction against the drive belt.

The second endless track may include an inner frame disposed therein and maintaining tension on both sides of the second endless track to maintain a flat shape of the first and second endless tracks in their endless rotation, and the inner frame may include frame belts disposed at both sides of the second endless track and installed along the first endless track, reinforcement frames connected to the frame belts to maintain a predetermined gap therefrom, and rotating rollers installed at the frame belts and rotated with the second endless track.

In addition, the moving belt may include a cover for covering an upper part of the moving belt and limiting motion of the user, and the cover may include a safety switch that can be pushed in an emergency.

### Advantageous Effects

As described above, a moving machine in accordance with the present invention is connected to a terminal for providing a virtual reality program to enable a user to experience a virtual reality, and allows the user to move in a direction provided by the virtual reality or desired by the user, thereby providing the virtual reality similar to an actual environment.

### BRIEF DESCRIPTION OF THE DRAWINGS

The above and other aspects and advantages of the present invention will become apparent and more readily appreciated from the following description of exemplary embodiments, taken in conjunction with the accompanying drawings in which:

FIG. 1 is a schematic front view showing a moving machine in accordance with an exemplary embodiment of the present invention;

FIG. 2 is a partially cut perspective view of a moving belt in accordance with an exemplary embodiment of the present invention;

FIG. 3 is a perspective view of a first drive module in accordance with an exemplary embodiment of the present invention;

FIG. 4 is a front view of the first drive module of FIG. 3;

FIG. 5 is a partially cut perspective view of a support member in accordance with an exemplary embodiment of the present invention;

FIG. 6 is a plan view of the support member of FIG. 5;

FIG. 7 is a plan view showing a cover installed at an upper part of the moving belt in accordance with an exemplary embodiment of the present invention;

FIG. 8 is a block diagram showing a control system of the moving machine in accordance with an exemplary embodiment of the present invention;

FIG. 9 is a perspective view of a second drive module in accordance with an exemplary embodiment of the present invention;

FIG. 10 is a front view of a third drive module in accordance with an exemplary embodiment of the present invention;

FIG. 11 is a partial cross-sectional view of the third drive module of FIG. 10;

FIG. 12 is a perspective view of a support block installed at the third drive module of FIG. 10;

FIG. 13 is a perspective view of an adhesion member installed at the third drive module of FIG. 10;

FIG. 14 is a partially cut perspective view of an inner frame in accordance with an exemplary embodiment of the present invention; and

FIG. 15 is a perspective view of the inner frame in accordance with an exemplary embodiment of the present invention.

### DESCRIPTION OF MAJOR REFERENCE NUMERALS

100: Moving machine 10: Frame

20: Moving belt 30: First drive module

40: Support member 50: Controller

60: Cover 70: Second drive module

80: Third drive module 90: Inner frame

10: Terminal 120: Head set

### BEST MODE FOR CARRYING OUT THE INVENTION

Reference will now be made in detail to the exemplary embodiments of the present invention, examples of which are illustrated in the accompanying drawings.

In the following description, various terms have been defined in consideration of functions of the present invention, yet they should not be construed as limiting the technical components of the present invention.

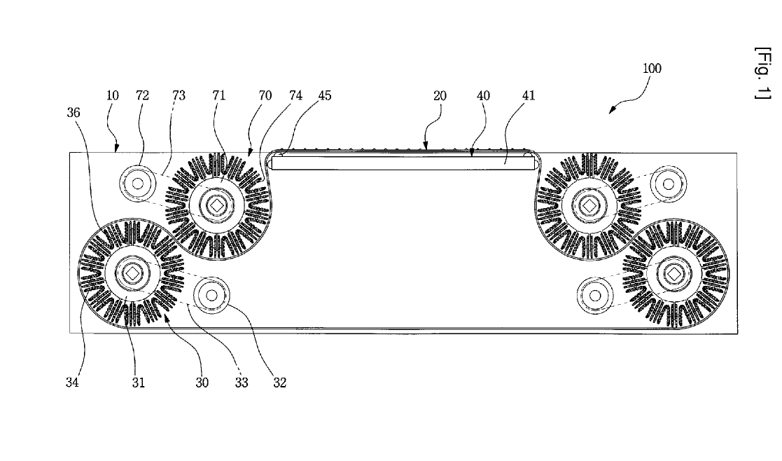

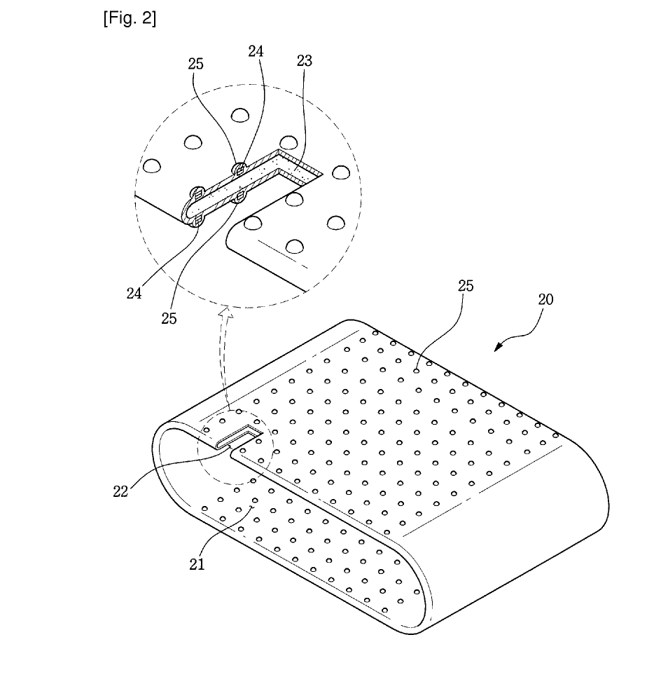

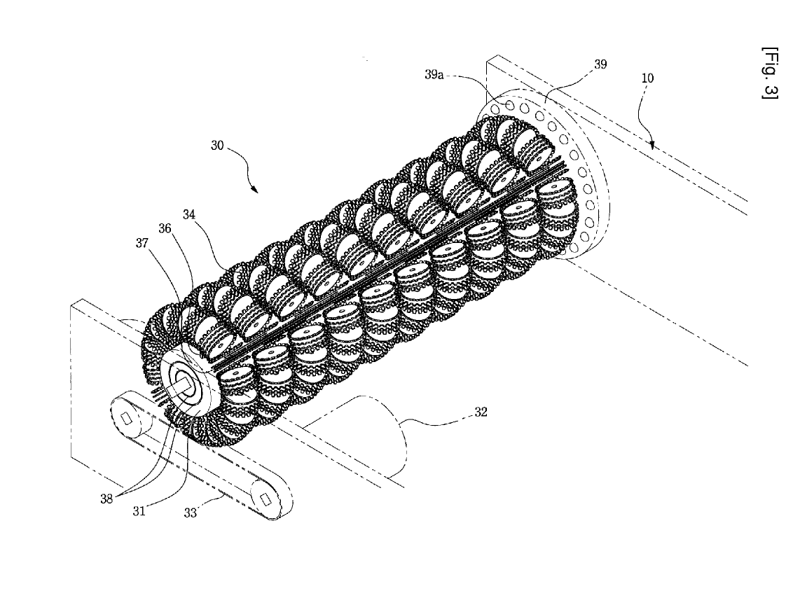

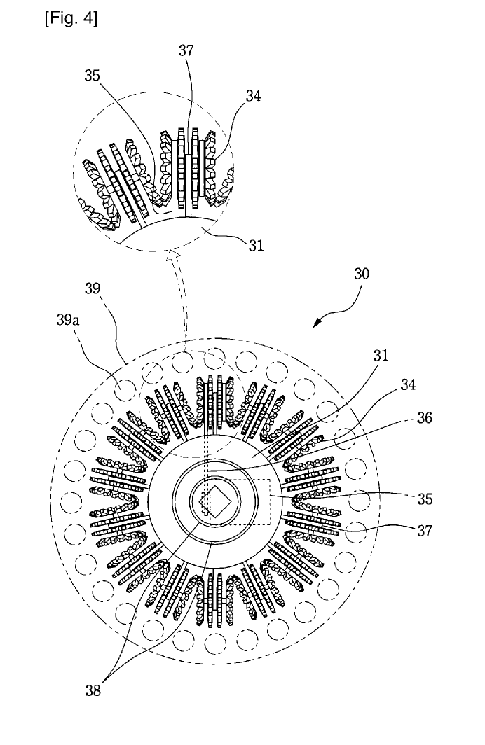

FIG. 1 is a schematic front view showing a moving machine in accordance with an exemplary embodiment of the present invention. In addition, FIG. 2 is a partially cut perspective view of a moving belt in accordance with an exemplary embodiment of the present invention. Further, FIG. 3 is a perspective view of a first drive module in accordance with an exemplary embodiment of the present invention, and FIG. 4 is a front view of the first drive module of FIG. 3.

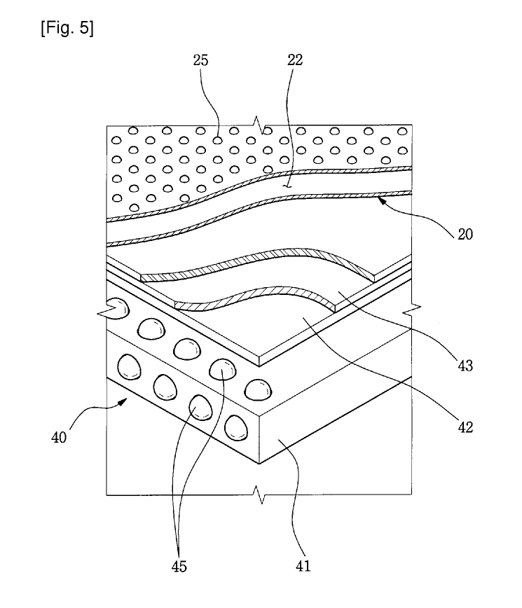

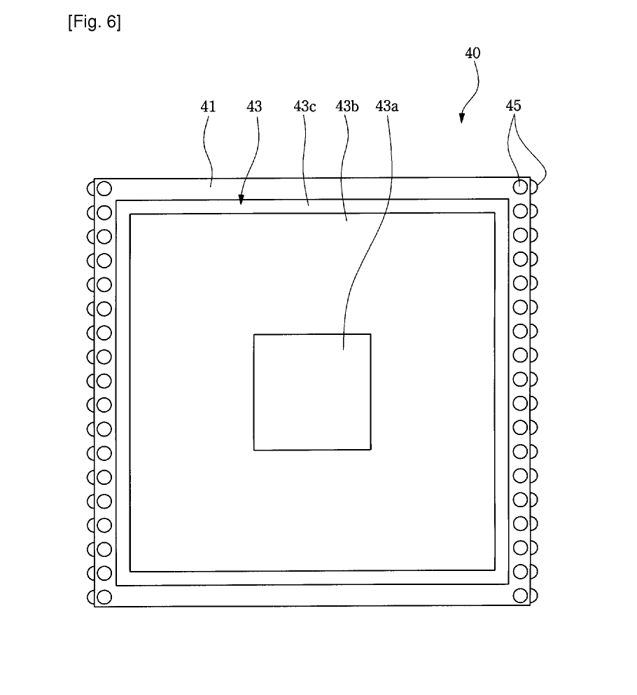

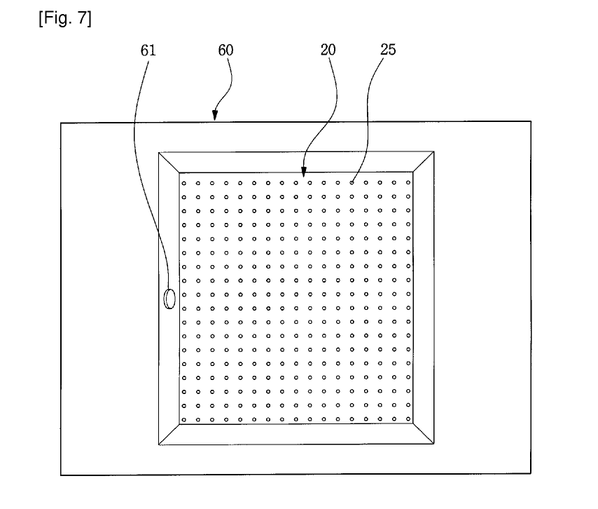

FIG. 5 is a partially cut perspective view of a support member in accordance with an exemplary embodiment of the present invention, and FIG. 6 is a plan view of the support member of FIG. 5. In addition, FIG. 7 is a plan view showing a cover installed at an upper part of the moving belt in accordance with an exemplary embodiment of the present invention, and FIG. 8 is a block diagram showing a control system of the moving machine in accordance with an exemplary embodiment of the present invention.

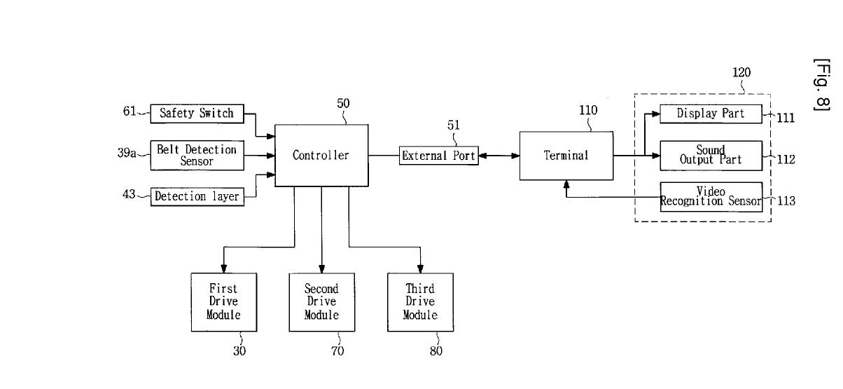

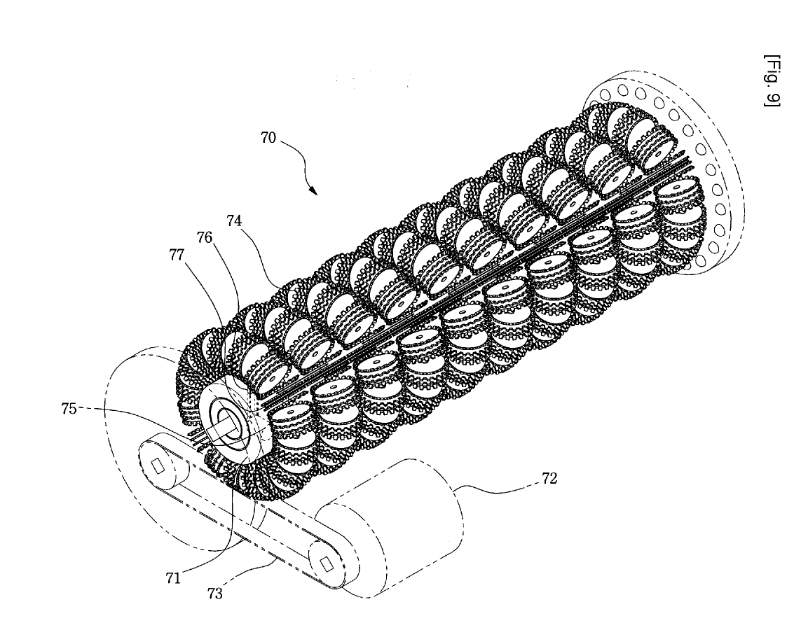

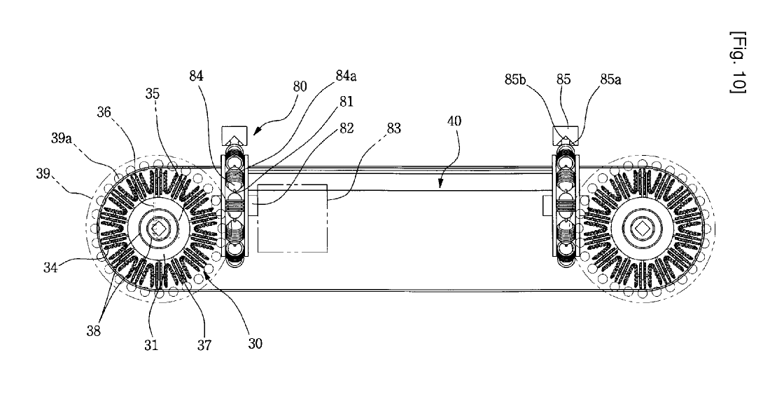

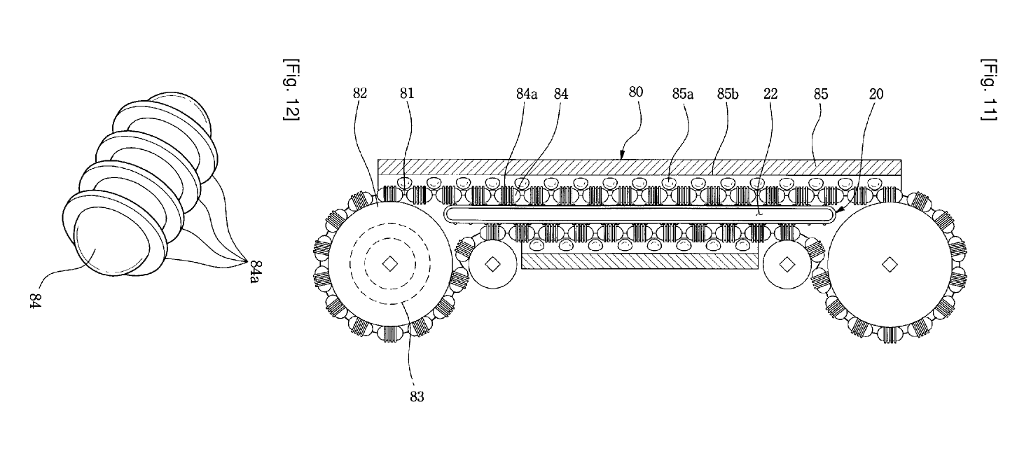

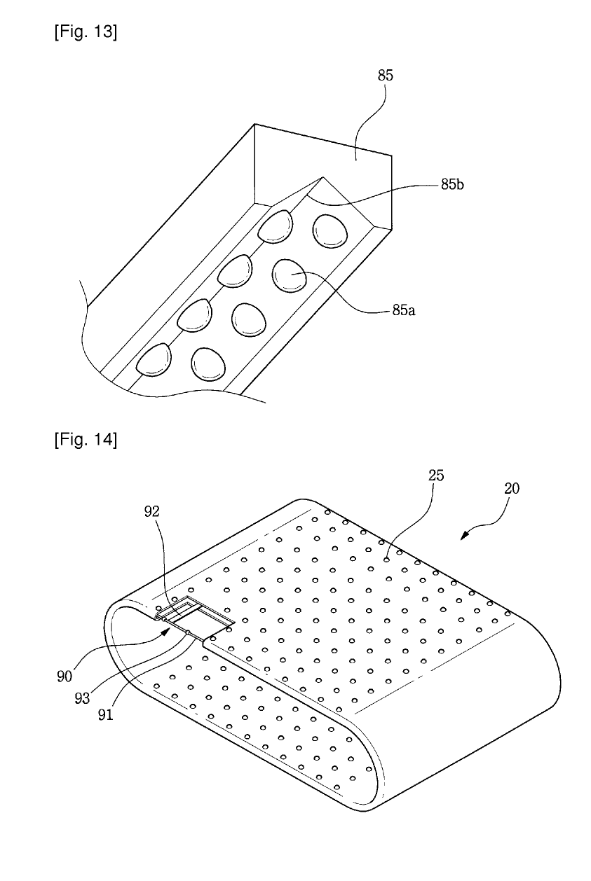

Meanwhile, FIG. 9 is a perspective view of a second drive module in accordance with an exemplary embodiment of the present invention, FIG. 10 is a front view of a third drive module in accordance with an exemplary embodiment of the present invention, FIG. 11 is a partial cross-sectional view of the third drive module of FIG. 10, FIG. 12 is a perspective view of a support block installed at the third drive module of FIG. 10, and FIG. 13 is a perspective view of an adhesion member installed at the third drive module of FIG. 10.

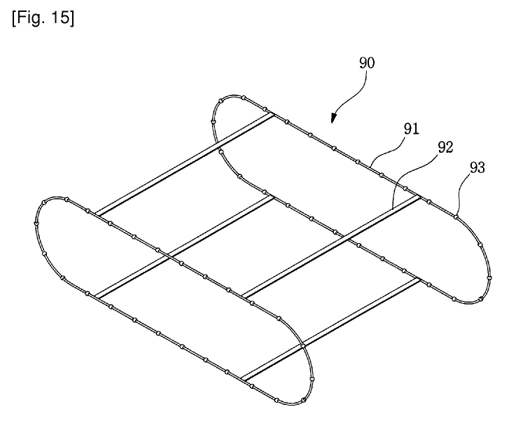

FIG. 14 is a partially cut perspective view of an inner frame in accordance with an exemplary embodiment of the present invention, and FIG. 15 is a perspective view of the inner frame in accordance with an exemplary embodiment of the present invention.

Referring to FIGS. 1 to 15, a moving machine 100 in accordance with the present invention, as shown in FIG. 1, includes a moving belt 20 having a first endless track 21 and a second endless track 22, a first drive module 30 for rotating the first endless track 21 and the second endless track 22, a controller 50 for controlling the first drive module, and a frame 10 for rotatably fixing the first drive module 30 and the moving belt 20.

Here, as shown in FIGS. 1 and 2, the moving belt 20 is formed of a flexible material. One end of a single dimensional tube, having the second endless track 22, and the other end thereof may be coupled to each other or integrally formed with each other to form the two-dimensional first endless track 21. Therefore, the second endless track 22 and the first endless track 21 have central axes perpendicular to each other.

In addition, the second endless track 22 is filled with a lubricant 23. Here, the lubricant 23 may be a gas lubricant or a fluid lubricant.

Further, a plurality of permanent magnets 24 are installed in the second endless track 22. Here, the permanent magnets 24 are parallelly disposed in the same direction such that the same polarities of the magnets are directed in a single direction. Therefore, upper and lower parts of the second endless track 22 are magnetically repulsed from each other due to repulsion force of the magnets opposite to each other such that upper and lower surfaces in the second endless track 22 are in non-contact with each other.

At this time, protrusions 25 are formed at an outer surface of the second endless track 22 to provide spaces for installing the permanent magnets 24 and performing finger-pressure treatment. Here, the protrusions 25 are larger than the permanent magnets 24 such that the permanent magnets 24 are inserted into the protrusions 25.

The protrusions 25 also function as means for transmitting a rotational power to the second endless track 22 using first rotary bodies 34, second rotary bodies 74, and support blocks 84.

The first drive module 30, as shown in FIGS. 1 to 4, includes first drums 31 parallelly disposed at inner left and right sides of the first endless track 21 to rotate the first endless track 21, first drive members 32 for driving the first drums 31, the first rotary bodies 34 for rotating the second endless track 22, and second drive members 35 for driving the first rotary bodies 34.

Here, the first drums 31 define inner spaces having a predetermined diameter and are disposed at the inner left and right sides of the first endless track 21 to maintain a predetermined tension of the first endless track 21. At this time, both longitudinal ends of the first guide drums are rotatably fixed to the frame 10.

Here, the frame 10 is coupled to the first drive members 32 for rotating the first drums 31, and includes first power transmission members 33 for transmitting a drive force of the first drive members 32 to the first drums 31. The first power transmission members 33 may be selected from gears, belts and pulleys, and chains and sprockets, and so on. The first power transmission members 33 may be omitted when rotary shafts of the first drive members 32 are fixed to the frame 10 or the first drums 31 are directly fixed to the rotary shafts of the first drive members 32 fixed to the frame 10.

The first rotary bodies 34 are coupled to an outer periphery of the first drums 31 to rotate the second endless track 22. Here, first support members 37 are installed at the outer periphery of the first drum 31 in a longitudinal direction thereof, and the first rotary bodies 34 are installed at the first rotary bodies 37.

At this time, the first support members 37 are radially disposed on the first drum 31, and the first rotary bodies 34 are coupled to the first support members 37 in a longitudinal direction thereof at predetermined intervals. Here, the first rotary bodies 34 installed at the first support members 37 are connected to gears or belts to be rotated in the same direction. In addition, the first rotary bodies 34 and the first drum 31 coupled as described above have central axes perpendicular to each other, and the moving belt 20 is in contact with the first rotary bodies 34.

Each of the first rotary bodies 34 includes two large first wheels 34a, and two small second wheels 34b. The first wheels 34a are disposed at a center of the first rotary body 34 and the second wheels 34b are disposed at both sides of the first wheels 34a such that the first drum 31 and the first rotary bodies 34 are coupled to form a circle. In addition, the first wheels 34a and the second wheels 34b have teeth to rotate the second endless track 22.

The first rotary bodies 34 having teeth installed at the first support members 37 are meshed with the first rotary bodies 34 installed at the first support members 37 adjacent thereto in a circumferential direction. Therefore, when any one of the first rotary bodies 34 is rotated, rotational force is transmitted to the adjacent first rotary body 34 installed at the first support member 37 such that the first rotary bodies 34 installed at the first drum 31 are rotated in the same direction.

A second drive member 35 is installed in the first drum 31 to rotate the first rotary bodies 34. In addition, a second power transmission member 36 is installed to transmit power from the second drive member 35 installed in the first drum 31 to the first rotary bodies 34 installed at the first support member 37. Here, the second power transmission member 36 may be selected from gears, belts and pulleys, and chains and sprockets.

Therefore, the first rotary bodies 34, the second drive members 35 and the second power transmission members 36 are installed at the first drums 31 installed at both sides of the frame 10 to rotate the first endless track 21 by rotation of the first drums 31 of the first drive members 32 and rotate the second endless track 22 by rotation of the first rotary bodies 34 by driving the second drive members 35.

As a result, an upper part of the moving belt 20 can be moved in lateral and reciprocal directions, as desired by a user, by the first endless track 21 and the second endless track 22 of the moving belt 20 under the control of the first drive members 32 and the second drive members 35. A controller 50 controls rotational speed of the first drive members 32 and the second drive members 35 to vary a moving direction as a user desires.

In addition, at least one connection terminal 38 is formed at the first drum 31 to apply an electric power and a control signal into the second drive member 35 installed in the first drum 31.

Further, belt guiders 39 are installed at both ends of the first drum 31 to prevent separation of the moving belt 20 from the first drum 31. Here, the belt guiders 39 are configured to form steps at both ends of the outer periphery of the first drum 31 to prevent the moving belt 20 from being separated from the first drum 31 when the second endless track 22 is rotated by the first rotary bodies 34. Therefore, the belt guiders 39 have a diameter larger than an outer diameter of the entire first rotary bodies 34 installed at the outer periphery of the first drum 31.

At this time, belt detection sensors 39a are installed at the belt guiders 39 to prevent separation of the moving belt 20 and detect approach of the moving belt 20 to the belt guiders 39. Here, the belt detection sensors 39 have a ball shape and are installed at sidewalls of the belt guiders 39 to reduce friction against the moving belt 20 when the moving belt 20 is in contact with the sensors 39a.

In addition, the detection signal of the moving belt 20 is transmitted to the controller 50. The controller 50 controls a drive speed of the second drive members 35 installed in the left and right first drums 31 on the basis of the detection signal detected by the belt detection sensors 39a installed at the first drums 31.

Further, as shown in FIGS. 1, 5, 6 and 7, a support member 40 is installed in the first endless track 21 to support the moving belt 20. The support member 40 includes a durable support layer 41, a magnetic layer 42 installed on the support layer 41, a detection layer 43 installed on the magnetic layer 42, and a lubricating layer 44 disposed on the detection layer 43 to avoid friction with the moving belt 20.

Here, the support layer 41 has a predetermined width and length to securely support the lower part of the moving belt 20 and a user on the moving belt 20. The support layer 41 may be supported on the floor or coupled to the frame 10.

In addition, the magnetic layer 42 is configured to have the same polarity as the permanent magnets 24 to provide repulsion force against the permanent magnets formed along the second endless track 22. At this time, the magnetic layer 42 may be formed of electromagnets having a polarity depending on power supply.

Further, as shown in FIG. 6, the detection layer 43 detects a user on the moving belt 20, and includes an outer detection layer 43b for detecting an outer part of the support member 40, an inner detection layer 43a for detecting an inner part of the support member 40, and an emergency detection layer 43c disposed on an outer periphery of the outer detection layer 43b.

Therefore, when a user is on the inner detection layer 43a, there is no action. When a user moves on the outer detection layer 43b, the controller 50 determines a moving direction of the user to control the first drive member 32 and the second drive member 35. In addition, when the user is on the emergency detection layer 43c, the controller 50 determines the emergency to stop the operation.

The detection layer 43 can detect a motion of a user s foot to control ON/OFF and deceleration/acceleration of the device on the basis of the number of pushes and a push time by a user s foot.

In addition, the lubricating layer 44, which is formed of synthetic resin or a metal material having lubricating qualities, is installed at the uppermost part as a plate or film shape to minimize friction with the moving belt 20 and protect the detection layer 43 thereunder.

Further, at least one first bearing is installed at a periphery of the support member 40 to reduce friction with the moving belt 20 disposed thereon. Here, the first bearing is installed at an upper periphery and side surfaces of the support member 40 to reduce friction when the first endless track 21 enters an upper part of the support member 40 or exits therefrom.

Furthermore, as shown in FIG. 7, a cover 60 is disposed on the moving belt 20, on which the support member 40 is disposed. Here, the cover 60 passes through the support member 40 to form a user s movement region, and the movement region is equal or similar to a periphery of the emergency detection layer 43c provided at the support member 40.

In addition, the cover 60 includes a safety switch 61 for rapidly controlling the moving machine 100 when the moving machine 100 operates abnormally or a hazard occurs.

As shown in FIG. 8, the controller 50 includes an external port 51 for communicating with a terminal 110 such as a desktop computer, a notebook computer, or a personal digital assistant in a wired or wireless manner.

Here, the computer is connected to the external port 51, and includes a drive program and a driver for driving the moving machine 100. The drive program is a virtual reality program for displaying a virtual reality. The computer includes a display part 111 for displaying a current virtual reality according to the virtual reality program, and a sound output part 112. The computer further includes a video recognition sensor 113 for detecting a viewing direction of a user.

At this time, the computer includes a wired or wireless headset 120 worn by a user. Here, the headset 120 may also include the sound output part 112, the display part 111, and the video recognition sensor 113. Here, the display part 111 may output a three-dimensional image.

Meanwhile, as shown in FIGS. 1 and 9, a second drive module 70 is installed outside the first endless track 21 of the moving belt 20 to rotate the first endless track 21 and the second endless track 22. Here, since components of the second drive module 70 are the same as or similar to the first drive module 30, the description of the same or similar components will not be repeated, and the other components will be described only.

Here, the second drive module 70 includes second drums 71 in contact with outer left and right sides of the first endless track 21 to rotate the first endless track 21, third drive members 72 for driving the second drums 71, third power transmission members 73, second rotary bodies 74 for rotating the second endless track 22, and fourth drive members 75 for driving the second rotary bodies 74.

The second drums 71 are spaced a predetermined gap from the first drums 31 and rotatably fixed to the frame 10 to be meshed with the first drums 31 with the moving belt 20 interposed therebetween. In addition, a plurality of second rotary bodies 74 are coupled to second support members 77 radially disposed on an outer periphery of the second drums 71, fourth drive members 75 are installed in the second drums, and fourth power transmission member 76 transmits a drive force from the fourth drive members 75 to the second rotary bodies 74.

At this time, the second drums 71 and the first drums 31 are meshed with the moving belt 20 interposed therebetween with a small force. That is, the second drums 71 is meshed with the first drums 31 with the second rotary bodies 74 coupled to the support members 77 radially disposed on an outer periphery of the second drum 71 being meshed with the first rotary bodies 34 coupled to the first drums 31.

Therefore, the second drum 71 and the first drum 31 are rotated in opposite directions, and the second rotary bodies 74 and the first rotary bodies 34 are in contact with outer upper and lower parts of the second endless track 22 to be rotated in the same direction.

Meanwhile, as shown in FIGS. 10 and 11, the moving machine includes a third drive module 80 to rotate the second endless track 22. Here, the third drive module 80 includes a drive belt 81 supporting outer upper and lower part of the second endless track 22 and rotated in an endless manner, third rotary bodies 82 for rotating the drive belt 81, and fifth drive members 83 for driving the third rotary bodies 82.

The drive belt 81 forms a closed loop to surround the second endless track 22 and to be in contact with the second endless track 22 to rotate the second endless track 22. In addition, support blocks 84 are installed at the drive belt 81 at predetermined intervals.

As shown in FIG. 12, the support blocks 84 are in close contact with an outer surface of the second endless track 22 by rotation of the drive belt 81, and at least one drive ring 84a is installed at an outer surface of the support block 84.

Here, the drive rings 84a are in close contact with the moving belt 20 to increase friction therewith and are hooked by the protrusions 25 formed at the moving belt 20 to rotate the moving belt 20. For this purpose, the drive rings 84a project outside the support blocks 84.

At this time, adhesion members 85 are provided on and under the drive belt 81 to uniformly press the drive belt 81 and adhere the drive belt 81 to the moving belt 20. As shown in FIG. 13, the adhesion member 85 has a predetermined length to be substantially adhered to the entire width of the second endless track 22 and includes second bearings 85a for reducing friction in a longitudinal direction thereof. In addition, the adhesion member 85 has a guide groove 85b for guiding the drive belt 81, and the second bearings 85a are installed in the guide groove 85b.

As shown in FIGS. 14 and 15, an inner frame 90 is installed in the moving belt 20. The inner frame 90 includes frame belts 91 installing the first endless track 21 at both inner sides of the second endless track 22, reinforcement frames 92 connecting the frame belts 91, and rotating rollers 93 for reducing friction generated when the second endless track 22 is rotated in an endless manner.

Therefore, the inner frame 90 is installed in the second endless track 22 to be rotated along the first endless track 21 in an endless manner, and the reinforcement frames 92 maintains a uniform flat shape of the second endless track 22.

In addition, the rotating rollers 93 are installed to be in contact with the second endless track 22 when the second endless track 22 is rotated in an endless manner to be rotated with the second endless track 22.

The moving machine may be adapted to the fields of virtual reality, virtual tours, simulation games, military simulation training, exercise apparatuses, and so on.

The foregoing description concerns an exemplary embodiment of the invention, is intended to be illustrative, and should not be construed as limiting the invention. Many alternatives, modifications, and variations within the scope and spirit of the present invention will be apparent to those skilled in the art.

1. A moving machine comprising:
a moving belt forming a first endless track by connecting both ends of a tube having a second endless track;
a first drive module coupled to both inner sides of the first endless track to rotate the first endless track and the second endless track;
a frame coupled to the first drive module to provide a predetermined tension to the first endless track; and
a controller for controlling the first drive module.

2. The moving machine according to claim 1, wherein the first drive module comprises:
a first drum rotatably fixed to the frame, and installed in the first endless track to rotate the first endless track;
a first drive member for driving the first drum;
a first rotary body installed to be in contact with the moving belt to rotate the second endless track; and
a second drive member for driving the first rotary body.

3. The moving machine according to claim 2, wherein the first drum comprises a first support member disposed at an outer periphery thereof and extending in a longitudinal direction thereof, the first rotary body is rotatably installed at the first support member, and the second drive member is installed in the first drum to rotate the first rotary body through a second power transmission member.

4. The moving machine according to claim 2, wherein the first drum comprises a belt guider coupled to both longitudinal sides thereof to guide the moving belt, and the belt guider comprises a belt detection sensor for detecting the belt to control the speed of the first rotary body.

5. The moving machine according to claim 4, wherein the belt guider is a frame for supporting the first drum, and the belt detection sensor is disposed on the frame.

6. The moving machine according to claim 1, wherein the second endless track is filled with a lubricant.

7. The moving machine according to claim 1, wherein the second endless track comprises permanent magnets in which the same polarities are disposed opposite to each other to prevent friction therebetween.

8. The moving machine according to claim 1, wherein the first endless track comprises a support member disposed therein and supporting the moving belt, and
the support member comprises:
a durable support layer for supporting a lower surface of the moving belt;
a magnetic layer disposed on the support layer and preventing friction using a magnetic force against the moving belt;
a detection layer for detecting a user on the moving belt; and
a lubricating layer disposed at the uppermost layer and reducing friction against the moving belt when the lubricating layer is in contact with the moving belt.

9. The moving machine according to claim 8, wherein the first endless track comprises first bearings installed at both edges of the support member and guiding the moving belt to reduce friction.

10. The moving machine according to claim 1, wherein the moving belt comprises a second drive module installed outside the first endless track to rotate the first endless track and the second endless track.

11. The moving machine according to claim 1, wherein the second endless track comprises a third drive module for supporting upper and lower parts of the second endless track and rotating the second endless track in an endless manner.

12. The moving machine according to claim 11, wherein the third drive module comprises:
a drive belt for forming a closed loop outside the second endless track and supporting upper and lower parts of the second endless track to rotate the second endless track in an endless manner;
a third rotary body for rotating the drive belt; and
a fifth drive member for driving the third rotary body.

13. The moving machine according to claim 12, wherein the drive belt comprises drive blocks installed at the drive belt at predetermined intervals and rotating the second endless track, and
the drive block comprises at least one drive ring disposed at an outer periphery of the drive block to increase traction with the second endless track.

14. The moving machine according to claim 12, wherein the drive belt comprises adhesion members disposed on and under the drive belt and pressing the drive belt to be in contact with the first endless track, and
the adhesion member comprises a second bearing for reducing friction against the drive belt.

15. The moving machine according to claim 1, wherein the second endless track comprises an inner frame disposed therein and maintaining tension on both sides of the second endless track to maintain flat shapes of the first and second endless tracks in their endless rotation.

16. The moving machine according to claim 15, wherein the inner frame comprises:
frame belts disposed at both sides of the second endless track and installed along the first endless track;
reinforcement frames connected to the frame belts to maintain a predetermined gap therefrom; and
rotating rollers installed at the frame belts and rotating with the second endless track.

17. The moving machine according to claim 1, wherein the moving belt comprises a cover for covering an upper part of the moving belt and limiting motion of a user, and
the cover comprises a safety switch that can be pushed in an emergency.
